(19) United States
(12) Patent Application Publication
(10) Pub. No.: US 2026/0087916 A1
(43) Pub. Date: Mar. 26, 2026

(54) SECURITY TAG

(71) Applicant: Sekura Global IP LLP, Colchester (GB)

(72) Inventors: Ben PERREAU, Mathews, NC (US); David CHRISTIANSON, Charlotte, NC (US)

(73) Assignee: Sekura Global IP LLP, Colchester (GB)

(21) Appl. No.: 19/107,666

(22) PCT Filed: Aug. 31, 2023
(86) PCT No.: PCT/GB2023/052245

§ 371 Date: Feb. 28, 2025

(30) Foreign Application Priority Data
Aug. 31, 2022 (GB) 2212576.9

(51) Int. Cl. G08B 13/24; G08B 15/02

(52) U.S. Cl. CPC G08B 13/2434; G08B 15/02

(57) ABSTRACT

A security tag for deterring theft of an article comprises: an activation sensor; a heating element; a power source configured to supply current to the heating element; and an attachment mechanism configured to secure the security tag to said article. The heating element is arranged to cause a permanent and visible change of state of said article upon application of a current to the heating element either by direct application of heat to said article or by releasing a substance from the security tag onto the article.

### FIELD OF THE INVENTION

This invention relates to security tags for use in retail environments to deter theft of an item to which the security tag is attached. This invention relates in particular to a benefit denial security tag, which is configured to damage or mark the item to which it is attached if the security tag is triggered. This invention also relates to a method of triggering a security tag, and in particular to a method of triggering a benefit denial security tag.

### BACKGROUND TO THE INVENTION

The majority of security tags attached to items in a retail store are configured to trigger an alarm if the item, and therefore the security tag, is removed from an area without deactivating the security tag. Typically these security tags operate by receiving a signal from an EAS gate or other structure at an exit of a retail store. If the security tag is activated, the receiving of the signal will cause the security tag to emit a response signal which will trigger an alarm. If, however, the security tag has been deactivated, for example at a point-of-sale upon purchase of the item, the response signal will not be emitted and the alarm will not be triggered.

While these security tags deter some thefts, it is still possible for a thief to remove the item from a retail store. The thief may evade any security measures that result from the triggering of the alarm, such as deployment of security personnel, for example by running from the retail store. The thief then retains the stolen item and can remove the security tag at a remote location.

To further deter theft of an item it is known to utilise benefit denial security tags. The concept of these tags is that if a thief attempts to steal an item or successfully removes an item from a retail store, the security tag will damage or destroy the item, thereby rendering it unusable or unsuitable for resale. A number of benefit denial security tags are known, including ink dye tags or oversized pin head tags.

Ink dye tags are configured to release permanent or indelible ink or dye onto a part of the item if somebody attempts to forcibly remove the security tag. The ink or dye is contained within a glass ampule within the tag which breaks to release the ink if sufficient force is applied to the tag. The ink or dye permanently marks the item so that the item is unusable.

Oversized pin head tags work on the basis that when a thief attempts to remove a security tag from an item it is necessary for the thief to cut or rip the item and pull the pin head through. If the pin head is designed to be particularly large, then the damage caused to the item when trying to remove the security tag means that the item is either effectively destroyed or is unusable.

Benefit denial security tags can, therefore, have significant advantages in deterring theft of items from a retail store. It will be appreciated, however, that, in both cases it is necessary for a significant force to be applied to the tag before damage occurs to the item.

Against this background, it is an aim of the present invention to provide an alternative and improved benefit denial security tag that overcomes at least one disadvantage of prior art security tags whether referred to herein or otherwise.

### SUMMARY OF THE INVENTION

A first aspect of the present invention provides a security tag for deterring theft of an article, the security tag comprising:
a heating element;
a power source configured to supply current to the heating element;
an activation sensor arranged to control the supply of current to the heating element; and
an attachment mechanism configured to secure the security tag to said article,
wherein, the heating element is arranged to cause a permanent and visible change of state of said article upon application of a current to the heating element either by direct application of heat to said article or by releasing a substance from the security tag onto the article.

At least a part of the heating element is preferably disposed at a surface of the security tag proximate the attachment mechanism, such that, in use, the heating element is held in contact with said article.

In some embodiments the security tag comprises a receptacle containing the substance. The heating element is preferably disposed in proximity to the receptacle so that, upon application of a current to the heating element, heat from the heating element causes a decrease in viscosity of the substance causing the substance to be released from the security tag. In preferred embodiments the substance is a hot-melt adhesive.

In other embodiments the security tag comprises a receptacle containing the substance and the heating element is disposed in proximity to the receptacle so that, upon application of a current to the heating element, the heating element creates an opening in the receptacle through which the substance is released. The substance may comprise a pigment or colourant.

Preferably the attachment mechanism comprises a pin or a cable.

In preferred embodiments the activation sensor is configured to receive a wireless trigger signal. The wireless trigger signal may be an acousto-magnetic signal, an electro-magnetic signal or a radio frequency signal.

A second aspect of the present invention provides a method of permanently marking an article to deter theft of said article, the method comprising:
providing a security tag attached to said article;
receiving, by an activation sensor of the security tag, a trigger signal;
upon receipt of the trigger signal, applying a current to a heating element of the security tag; and
maintaining the heating element in proximity to the article so that upon application of the current to the heating element the heating element is arranged to cause a permanent and visible change of state of said article either by direct application of heat to said article or by releasing a substance from the security tag onto the article.

In some embodiments, upon application of the current to the heating element, heat from the heating element damages a surface of the article by charring, discolouring or melting a part of said article. In other embodiments, upon application of the current to the heating element, heat from the heating element causes a decrease in viscosity of the substance causing the substance to be released from the security tag. In these embodiments the substance may be a hot-melt adhesive.

In further embodiments, upon application of the current to the heating element, heat from the heating element creates an opening in a receptacle of the security tag thereby causing release of the substance from the receptacle. Heat from the heating element may melt a part of a housing of the receptacle. The substance may comprise a pigment or colourant.

In preferred embodiments the security tag is attached to said article by a pin. In other embodiments the security tag may be attached to said article by a cable.

Preferably the trigger signal is a wireless trigger signal. The wireless trigger signal may be an acousto-magnetic signal, an electro-magnetic signal or a radio frequency signal.

In preferred embodiments the method comprises:
receiving, by the activation sensor of the security tag, a trigger signal sequence comprising a first trigger signal and a second trigger signal, the second trigger signal being different to the first trigger signal; and
upon receipt of the complete trigger signal sequence, applying the current to the heating element of the security tag.

In some embodiments the method may further comprise:
moving the security tag attached to the article from a first area in which the activation sensor is able to detect the first trigger signal into a second area in which the activation sensor is able to detect the second trigger signal; and
subsequently, moving the security tag attached to the article into a third area in which the activation sensor is unable to detect either of the first and second trigger signals.

Preferred and/or optional features of each aspect and embodiment described above may also be used, alone or in appropriate combination, in the other aspects and embodiments also.

### BRIEF DESCRIPTION OF THE DRAWINGS

The invention will now be further described by way of example only and with reference to the accompanying drawings, in which like reference signs are used for like features, and in which:

FIG. 1 is a schematic drawing of components of a security tag according to an embodiment of the present invention;

FIG. 2 illustrates part of a security tag according to an embodiment of the present invention;

FIG. 3 illustrates part of a security tag according to a further embodiment of the present invention;

FIG. 4 illustrates a first example system for triggering a security tag in a retail environment according to an aspect of the present invention; and

FIG. 5 illustrates a second example system for triggering a security tag in a retail environment according to an aspect of the present invention.

### DESCRIPTION OF THE PREFERRED EMBODIMENTS

A benefit denial security tag 10 according to the present invention is configured to be attached to an item or article within a retail unit or retail store. The benefit denial security tag 10 is switchable between an armed or activated mode and a disarmed or deactivated mode. When attached to an article and placed on display in the retail unit, the tag is in the activated mode.

A pair of pedestal antenna units of an electronic article surveillance (EAS) system are preferably disposed across a doorway of the retail unit in such a way that, for a person to exit the retail unit, it is necessary to pass through a sensing zone between the pedestal units.

A point of sale station is also provided in the retail unit. The point of sale station may include an electronic point of sale terminal. A security tag removal tool of the EAS system is located at the point of sale station.

As is known in the art, one of the pair of pedestal units is configured to transmit a trigger signal, which in this example is a radio-frequency (RF) signal at a predetermined frequency. The other pedestal unit is configured as a receiver to detect a response signal from the security tag 10 and/or a modification of the trigger signal as a result of the security tag being present in the sensing zone.

An article, with the benefit denial security tag 10 attached and in the activated mode, can be picked up and moved around an internal space of the retail unit with no response from the security tag 10 or the pedestal units. In normal circumstances, if the article is to be purchased, a customer will take the article to the point of sale station, whereupon the tag 10 is detached from the article using the tag removal tool. The tag 10 may also be switched into the deactivated mode by the tag removal tool and stored for re-use. The customer is then able to carry the article out of the retail unit without triggering a response from the benefit denial security tag or the pedestal units.

In the activated mode, the benefit denial security tag 10 is responsive to passage of the security tag 10 through the sensing zone between the pedestal units, as would occur during theft of the article.

The benefit denial security tag 10 comprises an activation sensor 12 and a benefit denial module 14 comprising a heating element 16 and a power source 18 configured to supply current to the heating element 16.

The activation sensor 12 is configured to detect the trigger signal transmitted by the transmitter pedestal unit. To this end, in this embodiment, the activation sensor 12 includes an RF tank circuit (also known as an LC circuit) comprising an inductor coil and a capacitor. The RF tank circuit is tuned to resonate at the frequency of the trigger signal. Resonance of the RF tank circuit is detected by the activation sensor 12, which responds by activating or triggering the benefit denial module 14.

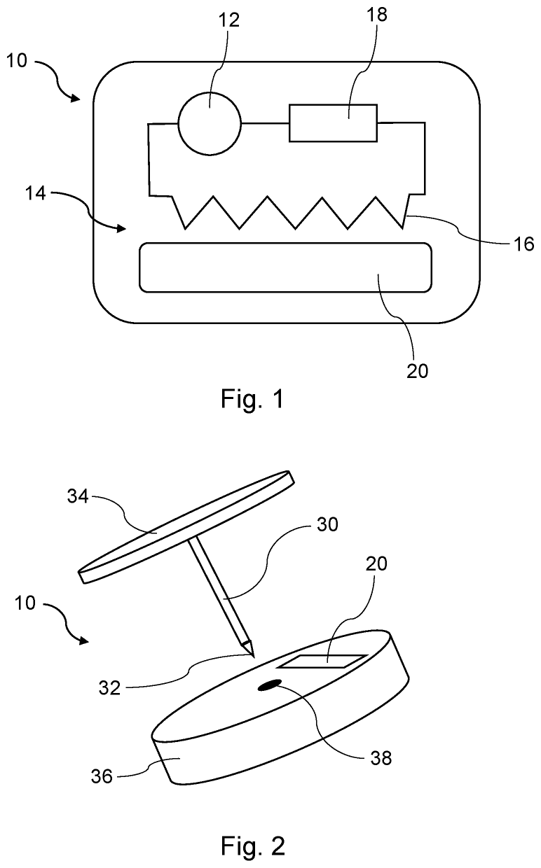

In a first preferred embodiment, illustrated in FIGS. 1 and 2, the benefit denial module 14 further comprises a substance held in a receptacle 20. The heating element 16 is disposed adjacent the receptacle 20 in the security tag 10. When the activation sensor 12 receives the trigger signal the benefit denial module 14 is triggered to supply current to the heating element 16 to cause the temperature of the heating element 16 to increase.

The substance in the receptacle 20 is selected such that the viscosity of the substance decreases with increasing temperature. In particular, the substance is preferably chosen such that, when heat is supplied to the substance by the heating element 16, the viscosity of the substance decreases sufficiently to enable the substance to flow out of the receptacle 20 and out of the security tag 10. Accordingly, the receptacle 20 preferably has an opening (not shown) through which the substance can flow. When the security tag 10 is attached to an article, the opening is preferably disposed in close proximity to the article. In this way, as the temperature of the substance increases, the substance flows out of the security tag 10 onto the article.

The benefit denial security tag 10 according to the invention is preferably configured to permanently mark or damage the article so that the article is unusable or is unsuitable for resale. This in turn deters theft of the article. To cause this permanent marking of or damage to the article, the substance preferably adheres to the article or causes some form of damage to the article, for example by discolouring or melting a part of the article. In preferred embodiments, the substance comprises a hot-melt adhesive. The hot-melt adhesive may include a pigment or colourant. The hot-melt adhesive may attach to the article in such a way that the article is damaged or destroyed if a person tries to remove the adhesive. The article may alternatively or additionally be damaged directly by contact with the hot-melt adhesive. For example a part of the article may itself melt due to the temperature of the adhesive, or a colourant carried by the hot-melt adhesive may permanently colour or dye a part of the article.

In other embodiments the substance may be in the form of a non-adhesive thermoplastic. In further embodiments the substance may have a melting point below the temperature of the heating element 16, such that when heat is supplied to the substance by the heating element 16, the substance melts and flows onto the article.

In these embodiments therefore, in use, if a person tried to remove an article from the retail unit with the activated security tag 10 attached, the activation sensor 12 will detect the trigger signal from the pedestal units at the exit of the retail unit. Receipt of this trigger signal will trigger the benefit denial module 14, and circuitry within the tag 10 will cause current to be supplied to the heating element 16. The increase in temperature of the heating element 16 then causes the substance, for example hot-melt adhesive, to flow out of the tag 10 and onto the article.

In a second preferred embodiment of a benefit denial security tag, the benefit denial module comprises a receptacle including a housing that fully surrounds a substance and does not initially include an opening. Upon application of a current to the heating element, the heat from the heating element creates an aperture in the housing to allow release of the substance from the receptacle. The heat from the heating element may, for example, cause melting of a part of the housing. The housing may include a window or panel made from a thermoplastic material or from a material with a relatively low melting point.

The substance held within the receptacle in these embodiments may be of any type which is able to permanently mark or damage an article. The substance may comprise an indelible pigment or colourant, the substance may be acidic, or the substance may include any other suitable chemical. The substance is preferably in the form of a liquid.

In these embodiments, in use, triggering of the security tag causes current to be supplied to the heating element as in the first embodiment. The increase in temperature of the heating element damages or changes the state of part of the receptacle allowing the substance, for example indelible ink, to flow out of the tag and onto the article.

The receptacle 20 may be of any suitable type and may be made of any suitable material. The receptacle 20 may be in the form of a cavity, chamber, reservoir or compartment.

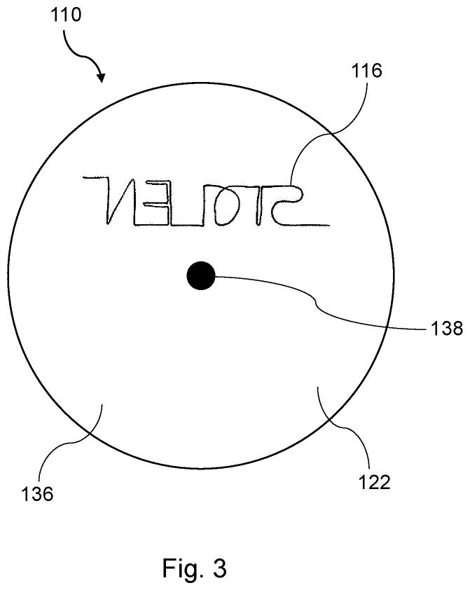

A third embodiment of a security tag 110 is illustrated in FIG. 3. In these embodiments the heating element 116 is disposed adjacent an outer surface 122 of the security tag 110. The heating element 116 may be disposed in an opening in a wall of the security tag 110, or the heating element 116 may extend through a wall of the security tag 110 and extend over an outer surface 122 of the security tag 110.

In use, the security tag 110 is attached to the article so that the heating element 116 is disposed in close proximity to a surface of the article. At least a part of the heating element 116 may be in contact with a surface of the article.

In this embodiment, when the benefit denial module is triggered, a current is supplied to the heating element 116 such that the temperature of the heating element 116 increases. The proximity of the heating element 116 to the article, or the contact between the heating element 116 and the article, means that the raised temperature of the heating element 116 causes charring or melting of a part of the article.

In some embodiments the heating element 116 may be shaped to mark the article with a symbol or word. In the illustrated embodiment the heating element 116 is formed to mark the article with the word STOLEN.

In all embodiments it is important that a part of the benefit denial security tag 10, 110 is held in close proximity to or in contact with a surface or area of the article to which the security tag 10, 110 is attached.

Benefit denial security tags 10, 110 according to the invention may be of any suitable form. Examples include box grips with lanyards or cables for attachment to boxes, pin tags for attachment to garments, adhesive labels, bottle tags for attachment to bottles, and many other configurations. In each embodiment at least one surface or wall of the security tag is in contact with or is adjacent to a surface of the article. The receptacle and/or heating element is therefore disposed in, at or adjacent this surface or wall of the security tag to cause the required damage or marking to the article upon triggering of the benefit denial module.

In the embodiments illustrated in FIGS. 2 and 3, the benefit denial security tag 10, 110 is in the form of a pin tag. A pin tag comprises a pin 30 including a sharp tip 32 and a head 34. The head 34 may be in the form of a relatively large disc. The pin tag further comprises a tag body 36, 136. The activation sensor, benefit denial module and associated circuitry are housed within the tag body 36, 136. The tag body 36, 136 also includes an opening 38, 138 for receiving the tip 32 of the pin 30 and an associated clutch mechanism or locking mechanism for retaining the pin 30 in engagement with the tag body 36, 136, as is known in the art.

In use, a part of an article, such as a garment, is positioned between the pin 30 and the tag body 36, 136. The pin 30 pierces the article and engages with the tag body 36, 136 so that the pin head 34 is disposed on a first side of the article and the tag body 36, 136 is disposed on a second side of the article. Preferably the article is clamped between the head 34 and the tag body 36, 136.

The receptacle 20 and/or heating element 16, 116 is preferably disposed in, at or adjacent the surface 22, 122 or wall of the tag body 36, 136 that includes the opening 38, 138 for receiving the pin 30. In this way, when the security tag 10, 110 is attached to the article, this surface 22, 122 is held in contact with or in close proximity to the article.

It will be appreciated that the benefit denial security tags 10, 110 of the present invention may include features known from existing tags in addition to or instead of those features described above.

For instance, in the above examples, the activation sensor 12 and pedestal units are configured to use radio-frequency signals. However, alternatively or in addition, the activation sensor 12 and pedestal units could be configured to use acousto-magnetic and/or electromagnetic technology as is known in the art of electronic article surveillance systems. A single pedestal unit, including an antenna for transmitting the activation signal and a receiver, may be used instead of a pair of pedestal units; similarly, more than two pedestal units may be provided. The antenna need not be provided in a pedestal unit, but could instead be provided in a unit for wall, floor or ceiling mounting or for mounting to a checkout aisle and so on.

Furthermore, benefit denial security tags 10, 110 of the present invention may additionally include an alarm module that is triggered upon receipt of the trigger signal by the activation sensor 12. The alarm module may include an audible and/or visual alarm. The security tag 10, 110 may, therefore, include one or both of a sounder (for example a buzzer) and a light emitter (for example an LED (light emitting diode)). An alarm module of a security tag 10, 110 and a benefit denial module 14 of a security tag 10, 110 may both be referred to as theft deterrent modules.

Circuitry within the benefit denial security tag 10, 110 may include a delay module or timer. This delay module may be configured such that a predetermined time elapses after receipt of the trigger signal before the benefit denial module 14 is activated, i.e. before current is supplied to the heating element 16, 116. In some embodiments including an alarm module, the circuitry may be configured such that the alarm is triggered immediately upon detection of the trigger signal. A predetermined time may then elapse before current is supplied to the heating element 16, 116 to cause release of the substance or direct damage to the article.

This time delay may allow time for the security tag 10, 110 to be deactivated or reset in situations in which the security tag 10, 110 had been triggered accidentally, for example by walking too close to a pedestal unit within a retail unit, or if a security tag 10, 110 has been left attached to an article or not deactivated properly after a verified purchase.

In these instances, if the benefit denial security tag 10, 110 is triggered accidentally, receipt of the trigger signal may cause an alarm to sound. This provides a warning to a customer and to store personnel that the security tag 10, 110 has been triggered. This may give the customer a chance to re-enter the store or move to a point of sale to allow the security tag 10, 110 to be deactivated and/or removed before the benefit denial module 14 is activated and the heating element 16 causes permanent damage to the article. Otherwise, once the predetermined time has elapsed, without deactivation of the security tag 10, 110, the circuitry within the tag 10, 110 causes current to be supplied to the heating element 16 to permanently mark or otherwise damage the article.

It will be appreciated that, because triggering the heating element 16 leads to permanent marking or damaging of the article, it is desirable if accidental or unintended triggering of the security tag 10, 110 can be avoided. In preferred embodiments, therefore, the benefit denial security tag 10, 110 may be used in combination with an EAS system comprising transmission of at least two different trigger signals in different locations. The activation sensor 12 of the security tag 10, 110 may be configured to detect a predetermined sequence of trigger signals before activating the benefit denial module 14. *

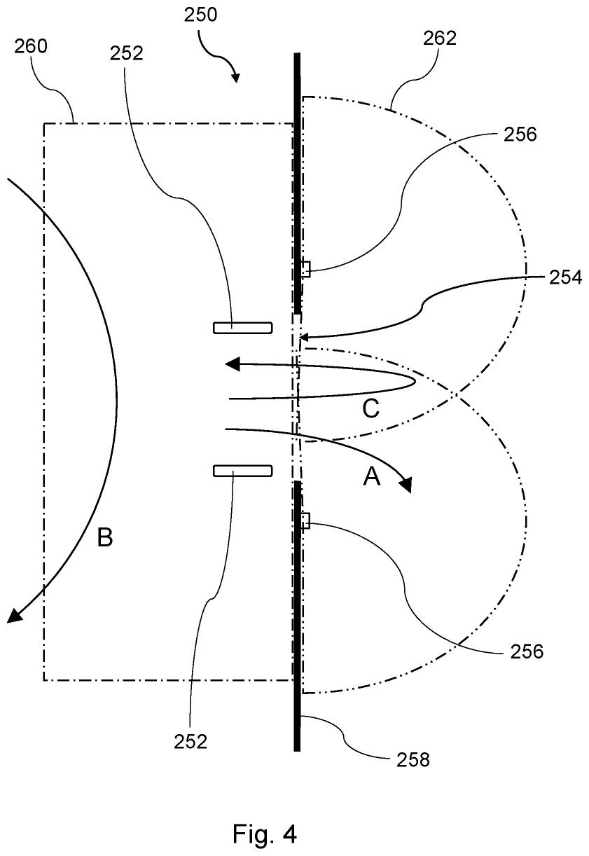

An example of an EAS system 250 for triggering a security tag 10, 110 is illustrated in FIG. 4. In the following description the EAS system 250 is described as being used in combination with a benefit denial security tag 10, 110 such as the security tag 10, 110 described above. The EAS system 250 may, however, be used in combination with any type of security tag.

In this example system, a pair of pedestal units 252 are located at an exit 254 of a retail store. The pedestal units 252 are located within an internal space of the retail store, adjacent the exit 254. One of the pair of pedestal units 252 is configured to transmit a first trigger signal to be received by an activation sensor 12 or EAS sensor of a security tag, as is known in the art.

The system 250 further comprises an external transmitter 256, in this example a pair of transmitters 256, disposed outside the retail store proximate the exit 254. The external transmitter may, for example, be mounted on an external surface of a wall 258 or window of the retail store. In this example first and second external transmitters 256 are located either side of the exit 254. The external transmitters 256 are configured to transmit a second trigger signal to be received by an activation sensor 12 or EAS sensor of a security tag.

The second trigger signal is different to the first trigger signal. In some embodiments the first and second trigger signals may be at different frequencies. In other embodiments the first and second trigger signals may be at the same frequency but may each transmit a different code to be detected by the activation sensor 12.

As illustrated in FIG. 4, the pedestal units 252 are preferably arranged to transmit the first trigger signal within a first predefined area 260 and the external transmitters 256 are preferably arranged to transmit the second trigger signal within a second predefined area 262. In this example, the first predefined area 260 is within an internal space of a retail store and the second predefined area 262 is external to a retail store. In some embodiments there may be overlap between the first and second predefined areas 260, 262. In other embodiments there may be a region between the first and second predefined areas 260, 262 in which no trigger signal is detectable. The first and second predefined areas 260, 262 are located such that a person must first pass through the first predefined area 260 and then pass through the second predefined area 262 as they exit the retail store.

The activation sensor 12 in a security tag 10, 110 may be configured to detect a predefined sequence of trigger signals. A security tag may be configured to only trigger an alarm or activate a benefit denial module 14 (for example the heating element 16 described above) if the complete sequence of trigger signals is received.

As an example, and referring to the embodiment of FIG. 4, the sequence of trigger signals may comprise firstly receiving a first trigger signal (within the first predefined area 260), subsequently receiving a second trigger signal (within the second predefined area 262), and then finally detecting a loss of both first and second trigger signals as the security tag leaves the second predefined area 262. This corresponds to a person fully exiting the store and then moving away to a remote location, as indicated by arrow A in FIG. 4.

If after detecting the first trigger signal (within the first predefined area 260) the activation sensor 12 does not detect the second trigger signal within a predetermined time after detecting the first trigger signal, then the full trigger signal sequence is not received and the security tag 10, 110 may be configured not to trigger an alarm or activate a benefit denial module 14. This corresponds to a situation in which a person passes close to the pedestals 252 and therefore enters the first predefined area 260, but remains within the store and moves away from the pedestals 252, as indicated by arrow B in FIG. 4.

In a third scenario, a person may pass through the pedestals 252 to leave the retail store such that they pass through the first predefined area 260 (leading to detection of the first trigger signal) and enter the second predefined area 262 (leading to detection of the second trigger signal). If they then become aware that they have an article to which a security tag 10, 110 is attached, they may then return to the interior of the retail store thereby re-entering the first predefined area 260. This is indicated by arrow C in FIG. 4.

This scenario may occur if, for example, a security tag includes an alarm and a benefit denial module 14 and circuitry in the tag is configured to trigger the alarm when the activation sensor 12 detects the first trigger signal followed by the second trigger signal, and to not trigger the benefit denial module 14 if the first trigger signal is detected after the second trigger signal. In this example, if a person leaves the retail store with a security tag 10, 110 still attached the alarm will sound or otherwise alert that person as soon as that person enters the second predefined area 262. The person then has the opportunity to return to the interior of the store without the benefit denial module 14 being activated to have the security tag 10, 110 removed or deactivated after verifying that a purchase has been made.

The predefined sequence of trigger signals may include one or more of a first predetermined time within which the second trigger signal must be detected after detection of the first trigger signal, a second predetermined time within which loss of both trigger signals must occur after detection of the second trigger signal, and a third predetermined length of time for which the loss of trigger signals must occur after detection of the first and second trigger signals.

By predefining a specific sequence of trigger signals that must be detected within predetermined times of each other, it is possible to accurately define a sequence corresponding to theft or unauthorised removal of an article from a retail store. In this way, accidental or unintended triggering of the security tag 10, 110 may be avoided.

In further embodiments the sequence of trigger signals may simply comprise detection of the second trigger signal after detection of the first trigger signal. Control circuitry within the security tag 10, 110 may then provide a predefined time delay before the benefit denial module 14 is activated. If the activation sensor 12 detects the first trigger signal again within the predefined time delay, the circuitry may be configured to cancel activation or triggering of the benefit denial module 14. This scenario relates to a person returning to the store after mistakenly exiting with a tagged article. If the first trigger signal is not detected within the predefined time delay, then the benefit denial module 14 will activate.

In a further embodiment the activation sensor 12 may activate control circuitry within the security tag 10, 110 upon detection of the second trigger signal. The control circuitry may then provide a predefined time delay before the benefit denial module 14 is activated. If the activation sensor 12 detects the first trigger signal within the predefined time delay, the control circuitry may be configured to cancel activation of the benefit denial module 14. This scenario relates to a person returning to the store after mistakenly exiting with a tagged article. If the first trigger signal is not detected within the predefined time delay, then the benefit denial module 14 will be activated.

While in the above embodiments the first trigger signal was transmitted by a pedestal, it will be appreciated that in other embodiments the first trigger signal may be transmitted by any suitable transmitter. Furthermore, while in the above embodiments the EAS system was described in relation to an exit of a retail store, the EAS system may be used in any environment or location in which movement of articles from one area to another is restricted. The EAS system may be used, for example, at entrances/exits of areas of a warehouse, factory or manufacturing facility. Accordingly, while the transmitters transmitting the second trigger signal are referred to above as external transmitters, they may be located within a building. The external transmitter(s) are preferably located external to an area in which the security tags are located while they are activated.

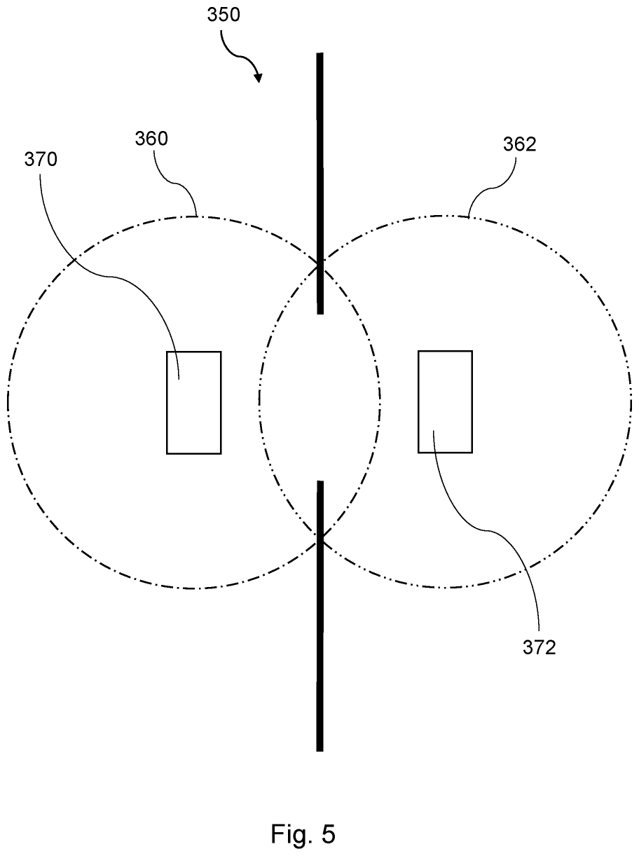

A further embodiment of an EAS system 350 for triggering a security tag 10, 110 is illustrated in FIG. 5. Some of the features of this system are identical to the features of the system described above and will not be repeated in relation to this embodiment.

Whereas in the previous embodiment the first trigger signal was transmitted from a traditional pedestal unit and the second trigger signal was transmitted from a wall mounted transmitter, in this embodiment both first and second trigger signals are transmitted or emitted from overhead units or panels. This removes the need to have pedestal units or the like impinging on the space at an entrance/exit of a retail store, which can improve the customer experience, as the EAS system is not immediately obvious to a customer.

In this embodiment the EAS system 350 comprises a first transmitter 370 configured to transmit or emit the first trigger signal to be received by an activation sensor 12 or EAS sensor of a security tag, and a second transmitter 372 configured to transmit or emit the second trigger signal to be received by an activation sensor 12 or EAS sensor of the security tag. The first transmitter 370 and the second transmitter 372 are preferably both ceiling mounted. The first transmitter 370 and the second transmitter 372 may, alternatively be mounted in a door frame or similar. The first transmitter 370 and the second transmitter 372 may be part of a concealed EAS system.

The first transmitter 370 is arranged to transmit the first trigger signal within a first predefined area 360 and the second transmitter 372 is arranged to transmit the second trigger signal within a second predefined area 362. In this example, the first predefined area 360 is within an internal space of a retail store and the second predefined area 362 is external to a retail store. Furthermore, in this embodiment there is an overlap between the first and second predefined areas 360, 362. In other embodiments there may be a region between the first and second predefined areas 360, 362 in which no trigger signal is detectable. The first and second predefined areas 360, 362 are located such that a person must first pass through the first predefined area 360 and then pass through the second predefined area 362 as they exit the retail store.

As described above, the activation sensor 12 in a security tag 10, 110 may be configured to detect a predefined sequence of trigger signals. A security tag may be configured to only trigger an alarm or activate a benefit denial module 14 (for example the heating element 16 described above) if the complete sequence of trigger signals is received. The predefined sequence of trigger signals may comprise firstly receiving a first trigger signal (within the first predefined area 360) and subsequently receiving a second trigger signal (within the second predefined area 362).

Other modifications and variations not explicitly disclosed above may also be contemplated without departing from the scope of the invention as defined in the appended claims.

1. A security tag for deterring theft of an article, the security tag comprising:
a heating element;
a power source configured to supply current to the heating element;
an activation sensor arranged to control the supply of current to the heating element; and
an attachment mechanism configured to secure the security tag to said article,
wherein, the heating element is arranged to cause a permanent and visible change of state of said article upon application of a current to the heating element either by direct application of heat to said article or by releasing a substance from the security tag onto the article.

2. A security tag according to claim 1, wherein at least a part of the heating element is disposed at a surface of the security tag proximate the attachment mechanism, such that, in use, the heating element is held in contact with said article.

3. A security tag according to claim 1, wherein the security tag comprises a receptacle containing the substance and the heating element is disposed in proximity to the receptacle so that, upon application of a current to the heating element, heat from the heating element causes a decrease in viscosity of the substance causing the substance to be released from the security tag.

4. A security tag according to claim 3, wherein the substance is a hot-melt adhesive.

5. A security tag according to claim 1, wherein the security tag comprises a receptacle containing the substance and the heating element is disposed in proximity to the receptacle so that, upon application of a current to the heating element, the heating element creates an opening in the receptacle through which the substance is released.

6. A security tag according to claim 5, wherein the substance comprises a pigment or colourant.

7. A security tag according to claim 1, wherein the attachment mechanism comprises a pin or a cable.

8. A security tag according to claim 1, wherein the activation sensor is configured to receive a wireless trigger signal.

9. A security tag according to claim 8, wherein the wireless trigger signal is an acousto-magnetic signal, an electro-magnetic signal or a radio frequency signal.

10. A method of permanently marking an article to deter theft of said article, the method comprising:
providing a security tag attached to said article;
receiving, by an activation sensor of the security tag, a trigger signal;
upon receipt of the trigger signal, applying a current to a heating element of the security tag; and
maintaining the heating element in proximity to the article so that upon application of the current to the heating element the heating element is arranged to cause a permanent and visible change of state of said article either by direct application of heat to said article or by releasing a substance from the security tag onto the article.

11. A method according to claim 10, wherein, upon application of the current to the heating element, heat from the heating element damages a surface of the article by charring, discolouring or melting a part of said article.

12. A method according to claim 10, wherein, upon application of the current to the heating element, heat from the heating element causes a decrease in viscosity of the substance causing the substance to be released from the security tag.

13. A method according to claim 12, wherein the substance is a hot-melt adhesive.

14. A method according to claim 10, wherein, upon application of the current to the heating element, heat from the heating element creates an opening in a receptacle of the security tag thereby causing release of the substance from the receptacle.

15. A method according to claim 14, wherein heat from the heating element melts a part of a housing of the receptacle.

16. A method according to claim 14, wherein the substance comprises a pigment or colourant.

17. A method according to claim 10, wherein the security tag is attached to said article by a pin or a cable.

18. (canceled)

19. A method according to claim 10, wherein the trigger signal is a wireless trigger signal in the form of an acousto-magnetic signal, an electro-magnetic signal or a radio frequency signal.

20. (canceled)

21. A method according to claim 10, wherein the method comprises:
receiving, by the activation sensor of the security tag, a trigger signal sequence comprising a first trigger signal and a second trigger signal, the second trigger signal being different to the first trigger signal; and
upon receipt of the complete trigger signal sequence, applying the current to the heating element of the security tag.

22. A method according to claim 21, the method further comprising:
moving the security tag attached to the article from a first area in which the activation sensor is able to detect the first trigger signal into a second area in which the activation sensor is able to detect the second trigger signal; and
subsequently, moving the security tag attached to the article into a third area in which the activation sensor is unable to detect either of the first and second trigger signals.
